(19) United States
(12) Patent Application Publication
(10) Pub. No.: US 2017/0282433 A1
(43) Pub. Date: Oct. 5, 2017

(54) OVERTURNING DEVICE FOR OVERTURNING MOLTEN MATERIAL IN A MELT CHANNEL AND PURGING METHOD

(71) Applicant: Windmöller & Hölscher KG, Lengerich (DE)

(72) Inventors: Martin BACKMANN, Lengerich (DE); Hermann-Josef JÄCKERING, Emsbüren (DE); Markus BUSSMANN, Essen (DE); Bernd LIESBROCK, Lengerich (DE); Karsten GOLUBSKI, Haltern am See (DE)

(21) Appl. No.: 15/508,155

(22) PCT Filed: Sep. 2, 2015
(86) PCT No.: PCT/EP2015/070001

§ 371 Date: Mar. 2, 2017

(30) Foreign Application Priority Data
Sep. 3, 2014 (DE) 10 2014 112 709.9

(51) Int. Cl. B29C 47/08; B29C 47/36; B29C 47/70; B29C 47/00

(52) U.S. Cl. CPC B29C 47/0879; B29C 47/0057; B29C 47/0813; B29C 47/0026; B29C 47/0874; B29C 47/362; B29C 47/705

(57) ABSTRACT

The present invention relates to an overturning device (10) for overturning a molten material (200) in a melt channel (110) comprising a melt inlet (20) and a melt outlet (30), wherein between the melt inlet (20) and the melt outlet (30) at least a melt guiding means (40) is assembled for a rearrangement of the molten material (200) from the centre (22) of the melt inlet (20) to the edge (34) of the melt outlet (30) and for a rearrangement of the molten material (200) from the edge (24) of the melt inlet (20) into the centre (32) of the melt outlet (30).

The present invention relates to an overturning device for overturning a molten material in a melt channel, a blow head for performing a blow film extrusion method and a method for the performance of a purge process in an extrusion device.

It is known that extrusion devices are used in order to produce a plastic melt. This plastic melt can be continued to use in different manners. Thus, it is for example possible to introduce the molten material in a cavity of an injection moulding device in order to generate the corresponding components by injection moulding. Further, it is known that the molten material is provided for a so called blow extrusion method with which a blow film is extruded. In all cases it is necessary that at the edge of the extruder the liquefied molten material is transported to the respective location of use via the corresponding melt channels. These channels can be arbitrarily complex and particularly separated to the single channels.

Disadvantageously with the known solutions of the extrusion device is that these involve a high effort for the change of material. Thus, a so called purge process must be performed in case a change of material from the first molten material to the second molten material should occur. If, for example, with a blow film extrusion device for a certain time a product with a blue film colour is produced and subsequently a change to a transparent film colour is desired, initially the blue film colour and the corresponding molten material has to be purged from the single melt channels. Herefore, the extrusion device is already operated with the subsequent material until the most of the old material of the molten material is purged out.

Since with melt channels in the edge area of these melt channels the transport speed is mainly equal to zero such that the old material so to say sticks and the purge process is very time consuming. With blow extrusion devices with a flow rate of up to approximately 120 kg molten material per hour thereby a purge process can normally require 20 minutes to 1.5 hours. For each film layer for which a material change should occur this leads to 120 kg or more of waste material of the molten material accordingly. With multiple film layers this amount is multiplied with the amount of film layers even if only one single film layer is purged. Thereby, waste rates of up to 1000 kg can be reached. Simultaneously, the purge time configures a dead time for the machine in which no useable production can occur. Accordingly, the known extrusion devices with the corresponding purge processes comprise significant disadvantages concerning the time effort and concerning the resulting costs and the waste of material.

It is object of the present invention to at least partially avoid the previously described disadvantages. Particularly, it is object of the present invention to reduce the time for the purge process in a cost efficient and simple manner.

The previous object is solved by an overturning device with the features of claim 1, a blow head with the features of claim 9 and a method with the features of claim 11. Further features and details of the invention result from the dependent claims, the description and the drawings. Thereby, features and details which are described in relation to the overturning device according to the invention naturally also apply in relation to a blow head according to the invention and the method according to the invention and vice versa such that according to the disclosure of the single aspects of the invention it can always be reciprocally related to.

An overturning device according to the invention serves for overturning a molten material in a melt channel. Hereby, the overturning device comprises a melt inlet and a melt outlet, wherein between the melt inlet and the melt outlet at least one melt guidance means is assembled. The melt guidance means serves for a rearrangement of the molten material from the centre of the melt inlet to the edge of the melt outlet. Further, the melt guidance means is configured for a rearrangement of the molten material from the edge of the melt inlet to the centre of the melt outlet.

By the centre of the melt channel thereby basically each area is to be understood that is separated from the edge. Particularly, a rearrangement occurs away from the edge. For example, the centre of the melt outlet of the whole melt outlet area can comprise a distance of approximately 5 mm to the edge.

By an overturning device according to the invention a rearrangement of the molten material in the melt channel occurs automatically without moveable parts by an active guidance with the help of a melt guidance means. The overturning device can be inserted into the melt channel or can be configured in a part of the melt channel. Via the melt inlet a fluid communicating connection to the melt channel is established such that the molten material can flow into the overturning device via the melt inlet. Subsequent to passing the melt inlet, the molten material is rearranged via the melt guidance means in a manner according to the invention. At the melt outlet the rearranged molten material leaves the overturning device and flows further in the melt channel via the fluid communicating connection.

According to the invention the melt guidance means are configured for the rearrangement of the molten material. Thereby, two basic layer functionalities are provided. At the melt inlet the molten material from the centre is used and is guided to the edge of the melt outlet. Simultaneously, and via the equal length a rearrangement of the molten material from the edge of the melt inlet into the centre of the melt outlet occurs. Therewith, the material from the centre of the melt inlet is exchanged with the material from the edge of the melt inlet such that at the melt outlet a complete rearranged melt layer situation occurs.

An overturning device according to the invention thus significantly reduces the purge time with the use of an extrusion device. Thus, in a purge situation in the extrusion device it can be assumed that old molten material in the area of the edge of the melt channel remains longer than in the centre. Thus, during the purge process the centre of the melt channel is relatively fast completed with fresh and therewith new molten material while at the edge still a high proportion of the old material remains. By the use of an overturning device according to the invention now a rearrangement of this old material from the edge of the melt channel into the centre of the melt channel occurs and therewith in the area of the fast and higher flow through rate. This leads to the situation that so to say old molten material in front of the overturning device is rearranged in the centre of the melt channel after the overturning device such that it can be now faster transported away in the centre. Thereby, that this rearrangement occurs in a manner according to the invention a significant reduction of the purge time can be achieved by a faster output of the old material from the melt channel.

Particularly, by an overturning device according to the invention a reduction up to 50% of the whole purge time can be achieved. A further advantage is the reduction of the resistance time of the molten material at the edge even in the normal operation. In this manner the thermal influence on the material can be reduced, wherein material restrictions are reduced or even avoided.

The overturning device can thereby be inserted in the melt channel or can configure the melt channel. Naturally, in the melt channel also two or more overturning devices can be provided with a defined distance. It is preferred, as subsequently described, if the overturning device is assembled mainly in the centre related to the length of the melt channel.

The melt guidance with the assistance of the melt guidance means can thereby be configured in different manners. Thus, the subsequently described functions in a division can be provided by a melt guidance means in the same manner as this is possible by an active guidance channel within the melt channel. These two different overturning functionalities are subsequently further described.

Thus it can be an advantage when with the overturning device according to the invention the at least one melt guidance means comprises a first guidance channel with a guidance opening in the centre of the melt inlet and at least one guidance outlet at the edge of the melt outlet. Here, thus an active overturning within a single melt channel occurs such that an installation of a separate overturning device is possible in an existing geometry of the melt channel. By a receiving in the guidance opening now the new or fresh material of the molten material is guided to the edge and put out at the melt outlet via the guidance outlet. There, it replaces the existing old material in the centre such that by a passive displacement here a complete rearrangement is achievable. Naturally however, a movement of the old material from the edge in the centre can occur actively like this is described in the subsequent paragraph by a second guidance channel. By a guidance channel a completely closed channel can be understood. However, partly open guidance channels at the lateral side in form of so called slides or ramps can be understood as guidance channel within the sense of the present invention. Accordingly, the guidance opening and the guidance outlet can comprise a completely outlined geometry or can be configured with a lateral opening.

It can be a further advantage when with the overturning device according to the previous paragraph the at least one melt guidance means comprises a second guidance channel with the guidance outlet in the centre of the melt outlet and at least one guidance opening at the edge of the melt inlet. Thereby, the second guidance channel so to say serves for the inverse functionality like the first guidance channel. Via the guidance opening molten material and therewith old material of the molten material can be received from the edge of the melt inlet and guided actively via the guidance outlet at the melt outlet with the second guidance channel in the centre. Therewith, not only by replacement, but by active guidance and replacement the corresponding replacement according to the invention from the edge to the centre and from the centre to the edge is enabled. The combination of two guidance channels is thereby preferably intended parallel such that the guidance opening of the first guidance channel and the guidance opening of the second guidance channel are assembled at the same or mainly the same position in the overturning device in flow direction. Simultaneously, it is an advantage when also the guidance outlet of the first guidance channel and the guidance outlet of the second guidance channel in relation to the flow direction are assembled in the same or mainly the same position at the melt outlet. Likewise, it is an advantage when all guidance channels of the at least one melt guidance means comprise the same or mainly the same free flow area in order to ensure a clean relocation, particularly with defined volume streams. Thereby, the single flow areas are preferably configured to provide the same or mainly the same flow velocities. Therewith, an undesired rupture of single layers from one another is prevented with a high probability and therewith a high security.

It is further an advantage when with the overturning device according to the invention the at least one melt guidance means comprises a separation section with a first separation channel and a second separation channel. Thereby, in front of the separation section a divisional section for dividing the molten material to the separation channel and after the separation area a combination section for merging the molten material from the separation channels is assembled. This configuration of a melt guidance means is naturally basically combinable with the melt guidance means of both previous paragraphs. By this separation function likewise a rearrangement can occur. Thus, via a divisional section the amount of molten material in the two separation channels is divided. This naturally also applies for the edge layer of the molten material such that in both separation channels only a part of the edge, namely particularly half of the edge is configured with old material while in the area of the divisional section the other half of the edge is already equipped with fresh material. If now the combination section for merging the molten material from the separation channels is geometrically aligned in a corresponding manner, this leads to the fact that at least a part of the edge layer with new material remains also with the combining with the separation flows of the molten material. Thus, by the functionality of the dividing and the combining likewise a possibility of a rearrangement according to the invention can be ensured. Particularly, such a partly rearrangement is combined with the corresponding separation channel sections with the guidance channels like it is described in the previous paragraphs.

An overturning device according to the previous paragraph can be further improved such that the combination section is configured for a central merging of the edge sections of the molten material. Thereby, it has to be understood that the explicit geometric alignment of the single separation channels in a combination section occurs. In case, for example, after the divisional section the edge sections with old material of the molten material are assembled at the outer side of the respective separation channel, thus the two separation channels can be merged in the combination channel, so that the two edge sections of the molten material are merged central in the separation channels with the old material. Thereby, a recombination of the separation streams of the molten material occurs by a complete or mainly complete rearrangement, thus that now by clever recombination of the part of the separation streams the edge section is relocated from the melt inlet into the centre of the melt outlet. Simultaneously, new material is rearranged from the centre of the melt outlet into the edge layers and therewith to the edge of the melt outlet. Thereby, preferably the respective diameter of the separation channels is adjusted to the diameter in front of the separation section and after the combination section.

A further advantage is achievable when with the overturning device according to the invention a shifting device is provided for shifting of the overturning device between a first position and a second position. In the first position the melt inlet and the melt outlet are in a fluid communicating connection with the melt channel. In the second position the melt inlet and the melt outlet are separated from the melt channel. Therewith, the shifting device can, for example, perform a movement of the overturning device in a translational, rotatory or in a combined manner. Particularly, thereby for the overturning device in the second position a tube part or a channel part is provided which connects the two remaining edge sections of the melt channel in a fluid communicating manner. The shifting device enables to switch on the rearrangement function so to say by the insertion of the overturning device and switching off by a pushing out of the overturning device. Since the overturning device generates a corresponding pressure loss situation by its overturning functionality, it is an advantage in the normal operation to switch off the overturning function. Therewith, the increased pressure loss only occurs during the purge process in order to ensure the corresponding rearrangement function. The increased pressure loss of the overturning device is switched off by pushing out the overturning device in the second position in the normal operation and is therefore not further able to interfere.

Further, it is an advantage when with the overturning device according to the invention the melt inlet and the melt outlet comprise a free flow area which corresponds or mainly corresponds to the free flow area of the melt channel. In other words, a fluid communicating connection between the melt inlet and the melt outlet or between the melt outlet and the melt inlet is enabled which is continuous without edges or variations in cross section. Such overturning device can be completely inserted into the melt channel or can even partly configure the melt channel. By a free flow area thereby the cross section perpendicular to the flow of the respecting position is to be understood. In other words, the free flow cross section of the flow cross section area is configured, via which the volume stream of the molten material can flow.

It is further advantageous when with the overturning device according to the invention the free flow area of the melt guidance means corresponds or mainly corresponds to the free flow area of the melt inlet and/or the free flow area of the melt outlet. Particularly, this embodiment is combined with the embodiment according to the previous paragraph. The flow cross section of the melt guidance means is thereby preferably the amount of all melt guidance means. By this corresponding a constant free flow area is provided such that the pressure loss by cross section restriction is avoided or mainly avoided. This significantly reduces the existing pressure loss with flowing through of the molten material. It remains or mainly remains only a pressure loss which is generated by the corresponding effect of the flow direction and therewith accordingly by the active rearrangement of the molten material. Thus, for example an expansion of the melt channel can permit such a geometrical correlation in the area of the overturning device. Further, it is conceivable that with division in a separation channel a corresponding adjustment of the flow cross sections via the corresponding cross sections of the separation channels is provided.

Likewise subject matter of the present invention is a blow head for the performance of a blow film extrusion device. Such a blow head comprises at least a melt channel for the conveyance of a molten material to the blow outlet of the blow head. A blow head according to the invention is further characterized in that at in the at least one melt channel at least one overturning device according to the invention is assembled. Thereby, the blow head according to the invention comprises the same advantages like they are described in detail in relation to the overturning device according to the invention. The melt channel thereby is in a fluid communicating connection with the melt inlet and the melt outlet of the overturning device.

Particularly, such a blow head with two or multiple melt channels is intended for different layers of the blow film. The overturning device is preferably assembled in the same or identical configuration in all melt channels in order to provide the same purge time reduction for all melt channels in a manner according to the invention.

A blow head according to the previous paragraph can be further improved in that the overturning device related to the length of the melt channel is assembled in the centre or mainly in the centre of the melt channel. Thereby, this is about an optimized positioning of the overturning device which ensures a maximum reduction of the purge time of about 50%. Naturally, also two or multiple overturning devices are possible which preferably are used with the same or identical division in the respective melting channel.

With a blow head according to the invention it is further possible that with a combination of two or multiple overturning devices one after the other each overturning device only covers a part of the respective edge and therewith rearranges the molten material in the centre only from this part of the edge. Thereby, preferably each overturning device can perform the rearrangement for another extent section such that after the passing of all overturning devices the molten material is rearranged from the entire edge into the centre. For example four overturning devices one after the other can cover 90° of the extent of the edge with a rearrangement function, respectively, such that the amount of the whole extent of 360° is rearranged.

A further embodiment of the present invention is a method for the performance of a purge process in an extrusion device, particularly in a blow head according to the present invention comprising the following steps:
Introducing a molten material into a melt inlet of an overturning device, particularly according to the present invention
Rearrangement of molten material from the centre of the melt inlet to the edge of the melt outlet of the overturning device, and
Rearrangement of molten material from the edge of the melt inlet into the centre of the melt outlet.

A method according to the invention comprises the same functionality according to the invention like the overturning device according to the invention such that the same advantages are achieved like they are described in detail in relation to the overturning device according to the invention.

Naturally, a blow head according to the invention and/or the corresponding overturning device in other extrusion units for example in a film extrusion, particularly in a flat film extrusion, can be used. Thereby, the blow head can be configured basically as an extrusion head.

Further advantages, features and details of the invention result from the subsequent description in which in relation to the drawings embodiments of the invention are described in detail. Thereby, the features described in the claims and in the description can be essential for the invention each single for themselves or in any combination. It is shown schematically:

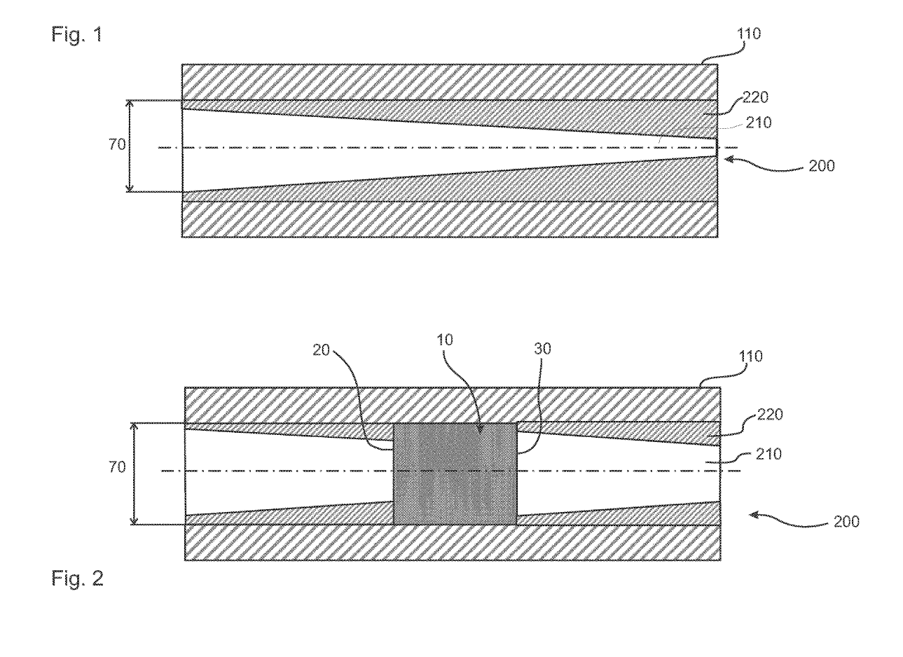

FIG. 1 a schematic representation during a purge process of known extrusion devices,

FIG. 2 a situation according to FIG. 1 with the use of an overturning device according to the invention,

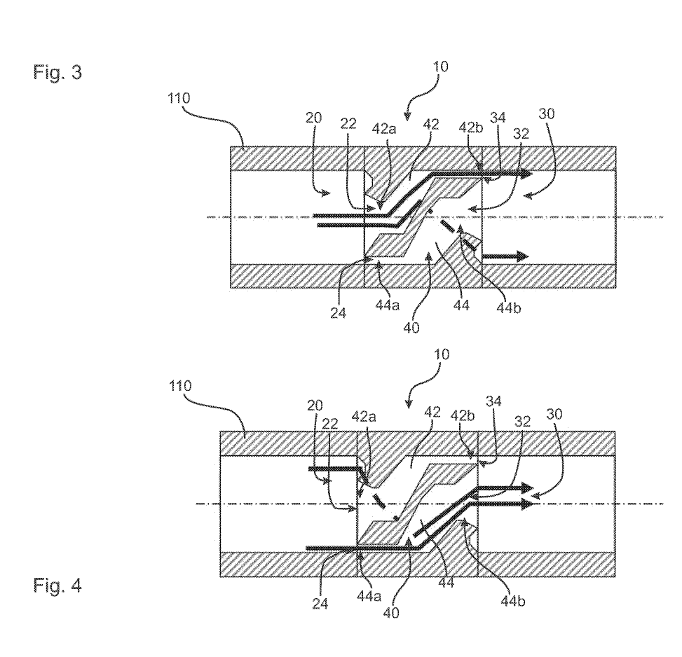

FIG. 3 an embodiment of an overturning device according to the invention,

FIG. 4 the embodiment of FIG. 3 with a further representation of flow conditions of the molten material,

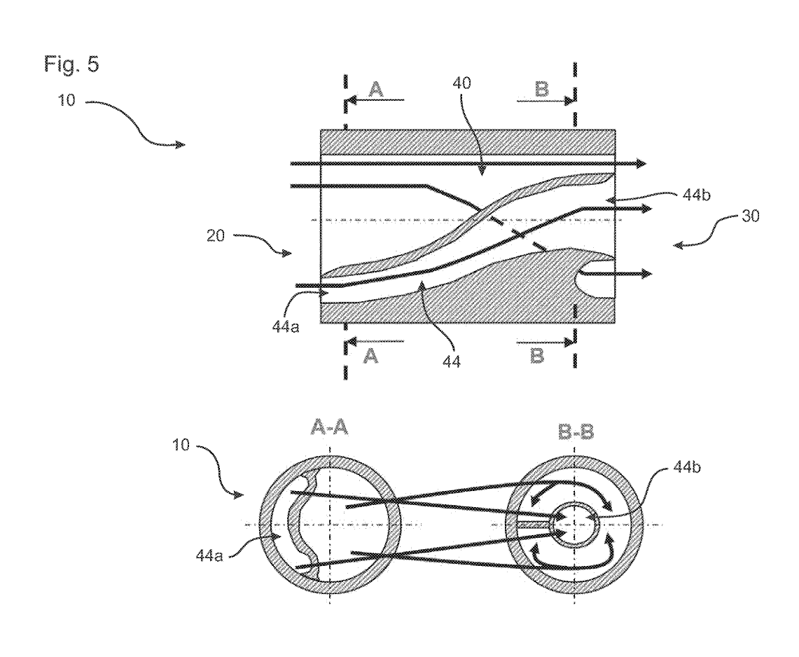

FIG. 5 a further embodiment of the overturning device according to the invention,

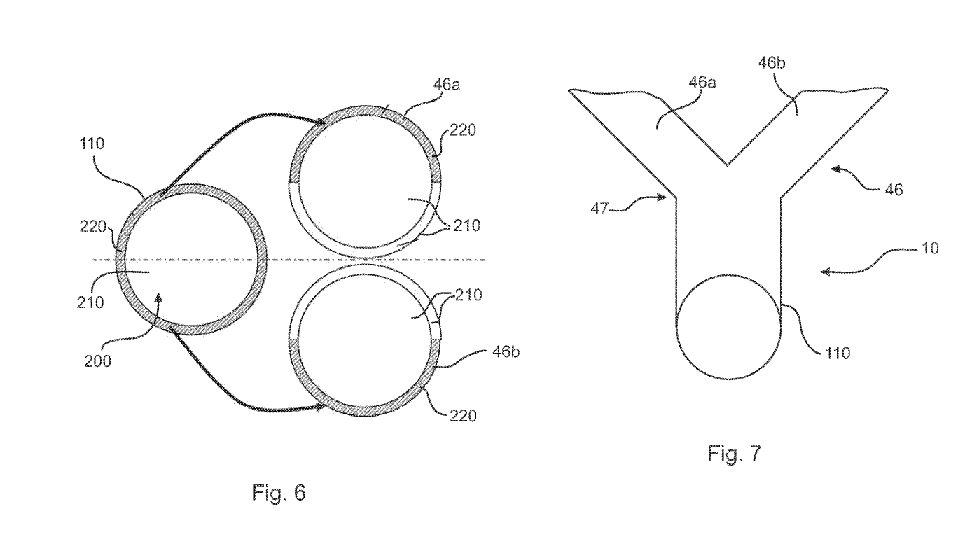

FIG. 6 a schematic representation of the effect of an overturning device,

FIG. 7 a further embodiment of an overturning device according to the invention,

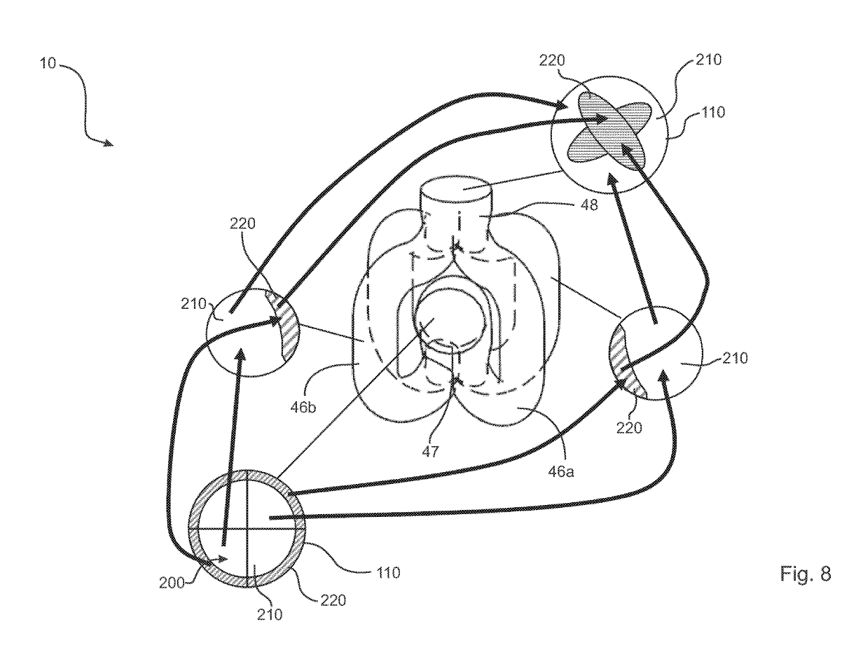

FIG. 8 a further embodiment of the overturning device according to the invention,

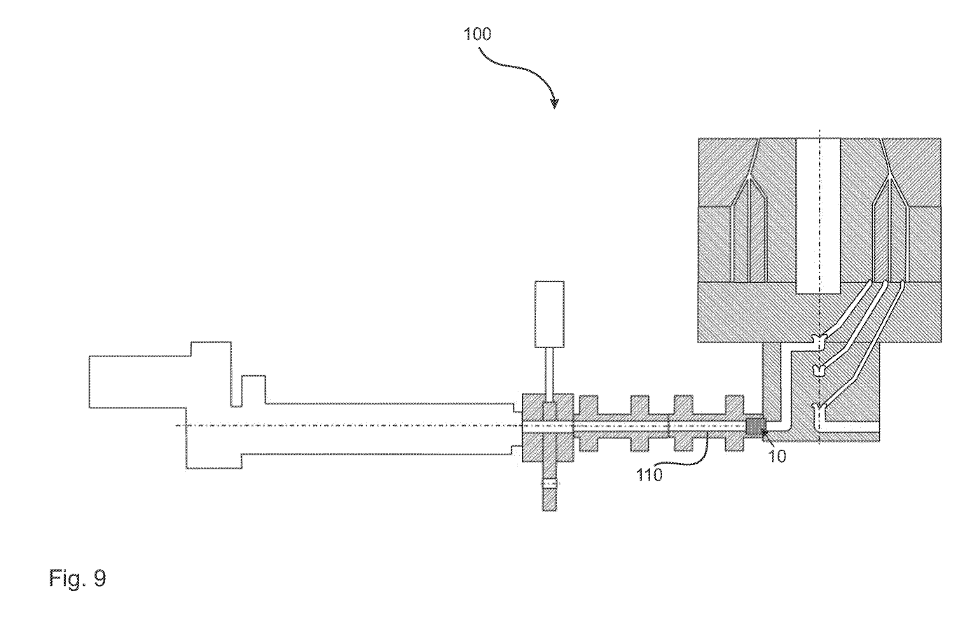

FIG. 9 an embodiment of a blow head according to the invention, and

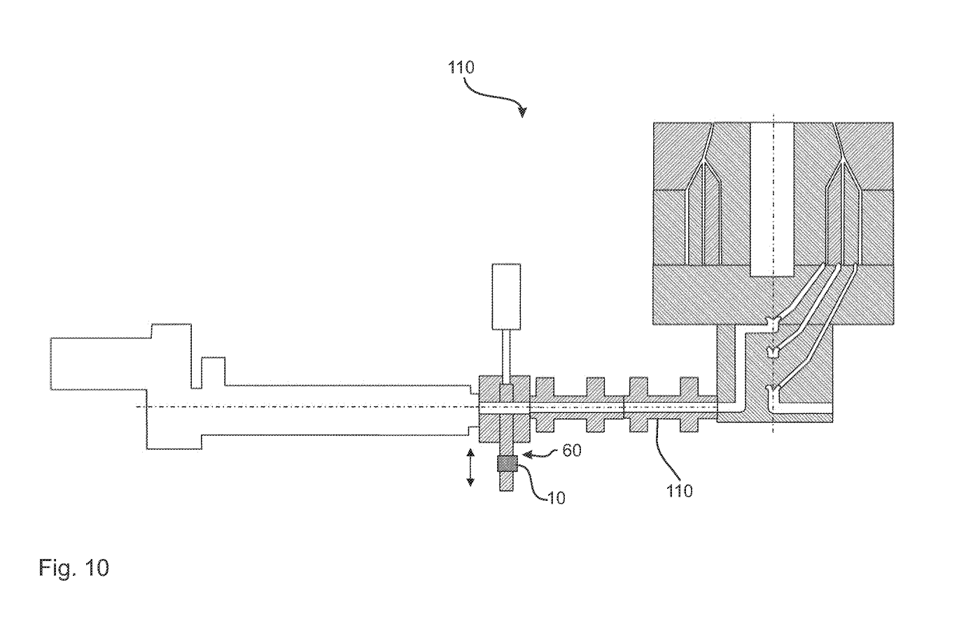

FIG. 10 a further embodiment of a blow head according to the invention.

In FIG. 1 a melt channel 110 with the flow direction from left to the right is shown like it is represented during the purge process. Within, the melt channel 110 a free flow area 70 is provided through which molten material 200 is flowing. Here, it has to be distinguished between old molten material 220 and new molten material 210. It can be recognized that via the longitudinal course of the melt channel 110 during the purge process a ramp-like or cone-like configuration between the old molten material 220 and the new molten material 210 is configured. This cone moves during the course of the purge time to the right until finally the greatest part of the old molten material 220 is pushed out and now it can be continued with an active production.

In FIG. 2 the mode of action of an overturning device 10 according to the invention is shown. Here now a rearrangement from the edge of the molten material 200 into the centre of the molten material 200 and vice versa occurs. At the melt inlet 20 of the overturning device 10 accordingly material is received from the edge of the molten material 200 and is provided in the centre at the melt outlet 30. In an inverse manner fresh or new molten material 210 is guided from the centre of the melt inlet 20 to the edge of the melt outlet 30. Like it can be recognized, therewith the adapted amount of old molten material 220 at the right end of the melt channel 110 is reduced. The representation of FIG. 2 occurs at the same time during the purge process like FIG. 1.

FIGS. 3 and 4 show a first embodiment of the overturning device 10 according to the invention. This overturning device 10 is configured with two guidance channels 42 and 44 as melt guidance means 40. Via a not further described ring collector a guidance opening 44a at the edge 24 of the melt inlet 20 is provided such that the corresponding molten material 200 can flow into the guidance channel 44. This is shown with arrows in FIG. 4. Via a guidance outlet 44b in the centre 32 of the melt outlet 30 now the rearrangement from the edge into the centre for this material of the molten material 200 occurs.

In the same manner in the centre 22 of the melt inlet 20 a guidance opening 42a of the first guidance channel 42 is provided, which renders it possible to rearrange the molten material 200 at the edge 34 of the melt outlet 30 and the corresponding guidance outlet 42b along the arrows of FIG. 3. This is a technical solution using an active rearrangement, wherein the overturning device 10 is part of the melt channel 110.

FIG. 5 shows a reduced complexity concerning the embodiment of FIG. 3 and FIG. 4. Here only a closed second guidance channel 40 with corresponding guidance openings 44a and guidance outlet 44b is provided. The remaining material of the molten material 200 is either not contacted at the upper edge guided through the melt guidance means 40 or guided at the lower edge starting from the melt inlet 20. The corresponding sections A-A and B-B are shown in the lower area of FIG. 5, wherein likewise the arrows show the corresponding rearrangement movements.

FIGS. 6 and 7 show the possibility to provide a rearrangement by a separation functionality. Starting from a melt channel 110 according to FIG. 7 via a divisional section 47 a division of the molten material 200 to two separation channels 46a and 46b of the separation section 46 occurs. This leads schematically to a distribution according to FIG. 6. While starting from the melt channel 110 old molten material 220 completely encloses the new molten material 210, by a separation in the separation channels 46a and 46b only approximately half of the extent with old molten material 220 is covered. The other half of the separation channels 46a and 46b is at the edge equipped with already new molten material 210. If now by clever combining the central merging of two separation channels 46 for the edge sections with the old molten material 220 is performed, likewise a complete or at least partial rearrangement according to the invention can occur by this separation function.

FIG. 8 schematically shows a further possible embodiment of an overturning device 10 with this separation functionality. Here, a separation in total four separation channels 46a and 46b and a recombining in a combination section 48 occur. Further, the corresponding distribution of old molten material 220 and new molten material 210 in the corresponding channels is schematically shown. After a combination or merging at the combination section 48 the edge sections with old material 220 are assembled in the centre such that the extent edge in the melt channel 110 is configured mainly completely by the new molten material 210.

FIG. 9 shows how in a melt channel 110 in a blow head 100 an overturning device 10 can be assembled. Thereby, each of the described embodiments of the overturning device 10 can be involved.

FIG. 10 shows a solution similar to FIG. 9, wherein however here a shifting device 60 for the overturning device 10 is shown. According to FIG. 10 the overturning device 10 is in the second position and therewith not in fluid communicating connection with the melt channel 110. This is the operation position. For the purge situation the overturning device 10 is introduced in the melt channel 110 via the shifting device 60 and therewith the functionality according to the invention for the reduction of the purge time can be provided.

The previous description of the embodiments describes the present invention only within the scope of examples. Naturally, single features of the embodiments as far as technically meaningful can be freely combined with one another without leaving the scope of the present invention.

### REFERENCE LIST

10 Overturning device

20 Melt inlet

22 Centre of melt inlet

24 Edge of melt inlet

30 Melt outlet

32 Centre of melt outlet

34 Edge of melt outlet

40 Melt guiding means

42 First guidance channel

42a Guidance opening

42b Guidance outlet

44 Second guidance channel

44a

Guidance opening

44b Guidance outlet

46 Separation section

46a First separation channel

46b Second separation channel

47 Divisional section

48 Combination section

60 Shifting device

70 Free flow area

100 Blow head

110 Melt channel

120 Blow output

200 Molten material

210 New molten material

220 Old molten material

1. An overturning device for overturning a molten material in a melt channel comprising a melt inlet and a melt outlet, wherein between the melt inlet and the melt outlet at least a melt guiding means is assembled for a rearrangement of the molten material from the centre of the melt inlet to the edge of the melt outlet and for a rearrangement of the molten material from the edge of the melt inlet into the centre of the melt outlet, wherein the at least one melt guiding means comprises a separation section with a first separation channel and a second separation channel, wherein in front of the separation section a divisional section for dividing the molten material to the separation channels and after the separation section a combination section from merging the molten material from the separation channels is assembled, wherein the combination section is configured for a central merging of the edge sections of the molten material, wherein a recombination of separation streams of the molten material occurs by a complete or mainly complete rearrangement.

2. The overturning device according to claim 1, wherein
the at least one melt guiding means comprises a first guidance channel with a guidance opening in the centre of the melt inlet and at least one guidance outlet at the edge of the melt outlet.

3. The overturning device according to claim 2, wherein
the at least one melt guidance means comprises a second guidance channel with a guidance outlet in the centre of the melt outlet and at least a guidance opening at the edge of the melt inlet.

4-5. (canceled)

6. The overturning device according to claim 1,
wherein
a shifting device is provided for a shifting of the overturning device between the first position in which the melt inlet and the melt outlet are assembled in a fluid communicating connection with the melt channel and a second position in which the melt inlet and the melt outlet are separated from the melt channel.

7. The overturning device according to claim 1,
wherein
the melt inlet and the melt outlet comprise a free flow area, which corresponds to or mainly corresponds to the free flow area of the melt channel.

8. The overturning device according to claim 7,
wherein
the free flow area of the melt guidance means corresponds or mainly corresponds at least to the free flow area of the melt inlet or to the free flow area of the melt outlet.

9. A blow head for performing a blow head extrusion method comprising at least a melt channel for the conveyance of molten material to a blow outlet of the blow head,
wherein
in the at least one melt channel at least one overturning device for overturning a molten material in a melt channel comprising a melt inlet and a melt outlet is assembled, wherein between the melt inlet and the melt outlet at least a melt guiding means is assembled for a rearrangement of the molten material from the centre of the melt inlet to the edge of the melt outlet and for a rearrangement of the molten material from the edge of the melt inlet into the centre of the melt outlet, wherein the at least one melt guiding means comprises a separation section with a first separation channel and a second separation channel, wherein in front of the separation section a divisional section for dividing the molten material to the separation channels and after the separation section a combination section from merging the molten material from the separation channels is assembled, wherein the combination section is configured for a central merging of the edge sections of the molten material, wherein a recombination of separation streams of the molten material occurs by a complete or mainly complete rearrangement.

10. The blow head according to claim 9, wherein
the overturning device with regard to the length of the melt channel is assembled in the centre or mainly in the centre of the melt channel.

11. A method for performing a purge process in an extrusion device, comprising the following steps:
Insertion of the molten material into a melt inlet of an overturning device for overturning a molten material in a melt channel comprising a melt inlet and a melt outlet, wherein between the melt inlet and the melt outlet at least a melt guiding means is assembled for a rearrangement of the molten materials from the centre of the melt inlet to the edge of the melt outlet and for a rearrangement of the molten material from the edge of the melt inlet into the centre of the melt outlet, wherein the at least one melt guiding means comprises a separation section with a first separation channel and a second separation channel, wherein in front of the separation section a divisional section for dividing the molten material to the separation channels and after the separation section a combination section from merging the molten material from the separation channels is assembled, wherein the combination section is configured for a central merging of the edge sections of the molten material,
Rearrangement of molten material from the centre of the melt inlet to the edge of the melt outlet of the overturning device and
Rearrangement of molten material from the edge of the melt inlet into the centre of the melt outlet,
wherein a recombination of separation streams of the molten material occurs by a complete or mainly complete rearrangement.
